(19) United States
(12) Patent Application Publication
(10) Pub. No.: US 2006/0278739 A1
(43) Pub. Date: Dec. 14, 2006

(54) INJECTION VALVE AND MANUFACTURING METHOD FOR THE SAME

(75) Inventors: Toyoji Nishiwaki, Anjo-city (JP); Nobuo Ota, Takahama-city (JP)

Correspondence Address: NIXON & VANDERHYE, PC, 901 NORTH GLEBE ROAD, 11TH FLOOR, ARLINGTON, VA, 22203, US

(73) Assignee: DENSO CORPORATION, Kariya-city (JP)

(21) Appl. No.: 11/422,117

(22) Filed: Jun. 5, 2006

(30) Foreign Application Priority Data
Jun. 7, 2005 (JP) 2005-166637
Apr. 25, 2006 (JP) 2006-120662

(51) Int. Cl. F02M 51/00

(52) U.S. Cl. 239/585.4; 239/585.1; 239/5

(57) ABSTRACT

A fuel injection valve includes a substantially cylindrical housing that at least partially surrounds an outer periphery of a coil. The housing is formed of a magnetic material. A fixed core and a movable core are located on a radially inner side of the coil. The movable core is opposed to the fixed core. The movable core is attracted to the fixed core by magnetic attractive force generated between the movable core and the fixed core. A valve is axially movable together with the movable core. A holder is formed of a magnetic material separately from the housing. The holder connects with a first axial end of the housing. The holder accommodates the valve. A cap is formed of a magnetic material separately from both the housing and the holder. The cap connects with a second axial end of the housing.

### CROSS REFERENCE TO RELATED APPLICATIONS

This application is based on and incorporates herein by reference Japanese Patent Applications No. 2005-166637 filed on Jun. 7, 2005 and No. 2006-120662 filed on Apr. 25, 2006.

### FIELD OF THE INVENTION

The present invention relates to an injection valve and a manufacturing method for the injection valve.

### BACKGROUND OF THE INVENTION

Generally, an injection valve has a solenoid actuator that includes a coil and a plate member. The plate member is formed of a magnetic material. The plate member circumferentially covers the outer periphery of the coil. The plate member is circumferentially divided into two pieces. The outer periphery of the coil is interposed between the two pieces. In this structure, the plate member does not entirely cover the circumferential outer periphery of the coil. Accordingly, the thickness of the plate member needs to be increased for sufficiently securing magnetic flux passing through the plate member. Consequently, the injection valve may be jumboized and weight of the injection valve may increase. The shapes of the axial ends of the plate member are different from each other, because the shapes of the axial ends are defined corresponding to the shapes of the coil and the outer periphery of the coil. Accordingly, the direction of the plate member needs to be predetermined with respect to the coil, when the plate member is assembled to the coil. Furthermore, the plate member needs to be welded or bonded to the coil. Consequently, manpower for manufacturing work of the injection valve increases.

According to U.S. Pat. No. 5,158,236 (JP-A-3-31570), a housing is formed of a magnetic material to be a substantially cylindrical member. In this structure of U.S. '236, the thickness of the housing is substantially uniform.

However, this cylindrical member is in a complicated shape having projections and depressions, in which the diameters of the cylindrical portions are different from each other. Accordingly, manufacturing process of the cylindrical member is complicated, and manpower for manufacturing the cylindrical member increases. In addition, the cylindrical member needs a fixing process such as welding and crimping. Consequently, the structure of the injection valve becomes complicated, and manpower for assembling the cylindrical member increases.

### SUMMARY OF THE INVENTION

In view of the foregoing and other problems, it is an object of the present invention to produce an injection valve that can be readily assembled. It is another object of the present invention to produce a method for manufacturing the injection valve.

According to one aspect of the present invention, an injection valve includes a coil that generates magnetism when being supplied with electricity. The injection valve further includes a housing that is in a substantially cylindrical shape. The housing at least partially surrounds an outer periphery of the coil. The housing has a first axial end and a second axial end. The first axial end is located on an opposite side of the second axial end with respect to an axial direction of the housing. The housing is formed of a magnetic material. The injection valve further includes a fixed core that is located on a radially inner side of the coil. The injection valve further includes a movable core that is located on a radially inner side of the coil. The movable core is opposed to the fixed core. The movable core is attracted to the fixed core by magnetic attractive force generated by the coil between the movable core and the fixed core. The injection valve further includes a valve that is movable together with the movable core with respect to an axial direction of the valve. The injection valve further includes a holder that is formed of a magnetic material separately from the housing. The holder connects with the first axial end of the housing. The holder accommodates the valve. The injection valve further includes a cap that is formed of a magnetic material separately from both the housing and the holder. The cap connects with the second axial end of the housing.

Alternatively, an injection valve includes a coil that has a first axial end and a second axial end. The coil generates magnetic flux when being supplied with electricity. The injection valve further includes a housing that is in a substantially cylindrical shape. The housing at least partially surrounds an outer periphery of the coil. The housing is formed of a magnetic material. The injection valve further includes a fixed core that is located on a radially inner side of the coil. The injection valve further includes a movable core that is located on a radially inner side of the coil. The movable core is opposed to the fixed core. The movable core is attracted to the fixed core by magnetic attractive force generated between the movable core and the fixed core. The injection valve further includes a valve that intermits injection of fuel through a nozzle hole by moving in conjunction with the movable core with respect to an axial direction of the valve. The injection valve further includes a holder that is formed of a magnetic material separately from the housing. The holder covers the first axial end of the coil. The injection valve further includes a cap that is formed of a magnetic material separately from both the housing and fixed core. The cap covers the second axial end of the coil.

Alternatively, a method for manufacturing an injection valve includes assembling a movable core to the holder, which accommodates a valve, such that the movable core being axially movable in conjunction with the valve with respect to the holder. The method further includes assembling a fixed core to the holder. The method further includes press-inserting the housing to the holder such that the housing surrounds an outer periphery of the fixed core so that the housing and the fixed core define a space therebetween. The method further includes inserting a substantially cylindrical coil into the space. The method further includes press-inserting a cap to the housing on an opposite side of the holder.

Alternatively, a method for manufacturing an injection valve includes inserting a valve into an inner periphery of a holder such that the valve is axially movable in the holder. The method further includes assembling a movable core to the holder such that the movable core is axially movable in conjunction with the valve with respect to the holder. The method further includes assembling a fixed core to the holder. The method further includes press-inserting any one of a first axial end and a second axial end of the housing to the holder, such that the housing surrounds an outer periphery of the fixed core so that the housing and the fixed core define a space therebetween. The method further includes inserting a substantially cylindrical coil into the space. The method further includes press-inserting a cap to an other of the first axial end and the second axial end of the housing on an opposite side of the holder

### BRIEF DESCRIPTION OF THE DRAWINGS

The above and other objects, features and advantages of the present invention will become more apparent from the following detailed description made with reference to the accompanying drawings. In the drawings:

FIG. 1 is a longitudinal partially sectional view showing an injection valve, according to a first embodiment;

FIG. 2 is a top view when being viewed from the arrow II in FIG. 1;

FIG. 3 is a longitudinal sectional view showing a core assembly of the injection valve, according to the first embodiment;

FIG. 4 is a longitudinal sectional view showing a housing assembled to the core assembly, according to the first embodiment;

FIG. 5 is a longitudinal sectional view showing a coil assembly assembled to the core assembly, according to the first embodiment;

FIG. 6 is a longitudinal sectional view showing a cap assembled to the core assembly and the coil assembly, according to the first embodiment;

FIGS. 7A to 7F are longitudinal sectional views showing housings of the injection valve, according to modifications of the first embodiment;

FIG. 8 is a longitudinal partially sectional view showing an injection valve, according to a second embodiment;

FIG. 9 is a side view when being viewed from the arrow IX in FIG. 8;

FIG. 10 is a longitudinal partially sectional view showing an injection valve, according to a third embodiment;

FIG. 11 is a side view when being viewed from the arrow XI in FIG. 10; and

FIG. 12 is a longitudinal partially sectional view showing an injection valve, according to a variation embodiment.

### DETAILED DESCRIPTION OF PREFERRED EMBODIMENTS

### First Embodiment

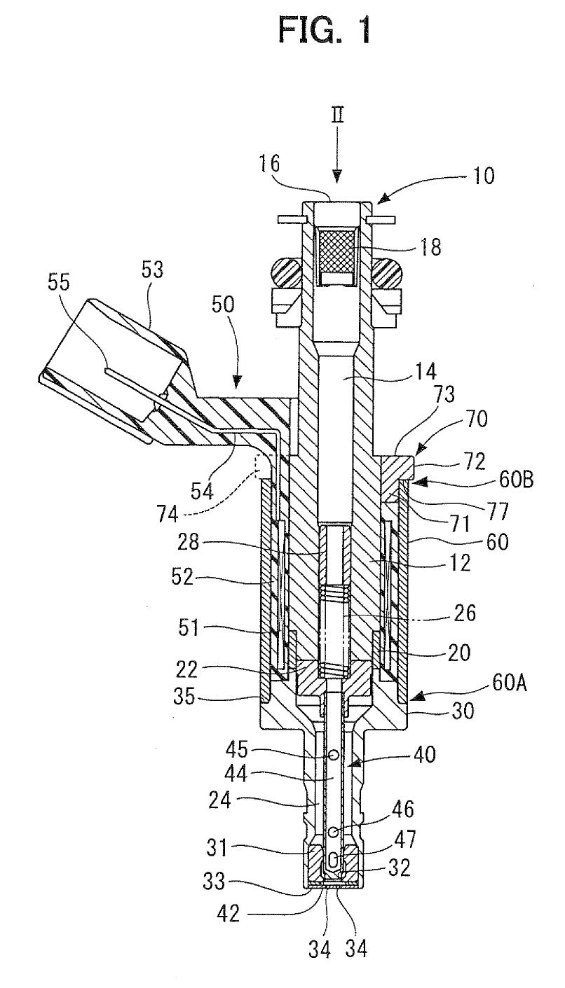

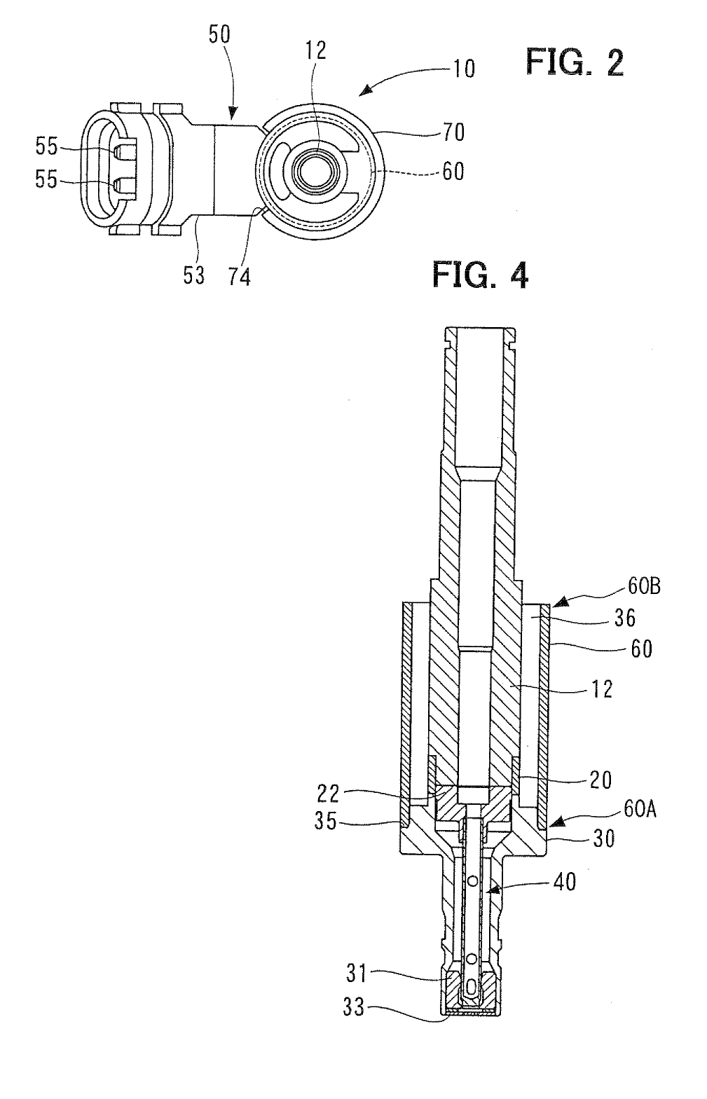

As shown in FIGS. 1, 2, a fuel injection valve (injector) 10 is applied to a gasoline engine such as a direct-injection engine or a port direct-injection engine. The injector 10 may be applied to a diesel engine.

The injector 10 includes a fixed core 12 that is formed of a magnetic material to be in a substantially cylindrical shape. The fixed core 12 has a fuel passage therein. The fixed core 12 has an axial end that has a fuel inlet 16, into which fuel is supplied from a fuel tank using a fuel pump (not shown). Fuel supplied to the fuel inlet 16 flows into the fuel passage 14 in the fixed core 12 through a filter 18. The filter 18 removes foreign matters contained in fuel.

The end of the fixed core 12 on the opposite side of the fuel inlet 16 makes contact with a non-magnetic member 20, which is formed of a non-magnetic material to be in a substantially cylindrical shape. The end of the non-magnetic member 20 on the opposite side of the fixed core 12 connects with a holder 30, which is formed of a magnetic material to be in a substantially cylindrical shape. The end of the holder 30 on the opposite side of the fixed core 12 accommodates a valve body 31. The fixed core 12 and the non-magnetic member 20 are connected by welding or the like therebetween. The non-magnetic member 20 and the holder 30 are connected by welding or the like therebetween. The non-magnetic member 20 restricts the fixed core 12 and the holder 30, which are formed of magnetic materials, from causing shortcircuit magnetically therebetween.

The valve body 31 is in a substantially cylindrical shape. The valve body 31 is fixed to the inside of the holder 30 by press-insertion, welding, or the like. The valve body 31 has a substantially conical inner wall surface, which decreases in inner diameter toward the tip end thereof. The inner wall surface of the valve body 31 defines a valve seat 32. The end of the valve body 31 on the opposite side of the fixed core 12 is provided with a nozzle plate 33. The nozzle plate 33 has at least one nozzle hole 34, which is a through hole extending in a substantially thickness direction of the nozzle plate 33. The at least one nozzle hole 34 communicates the interior of the valve body 31 with the exterior of the valve body 31. The number of the at least one nozzle hole 34 may be one, or may be equal to or greater than two.

The holder 30 accommodates a movable core 22 and a needle 40. The needle 40 serves as a valve. The movable core 22 is substantially axially movable on the radially inner side of the non-magnetic member 20 and the holder 30. The outer periphery of the movable core 22 makes contact with the inner peripheries of the non-magnetic member 20 and the holder 30, so that the movement of the movable core 22 is guided by the inner peripheries of the non-magnetic member 20 and the holder 30. The movable core 22 is formed of a magnetic material such as a ferrous material to be in a substantially cylindrical shape. The end of the movable core 22 on the opposite side of the fixed core 12 is integrally connected with the needle 40.

The needle 40 is accommodated on the radially inner side of the holder 30 and the valve body 31. The needle 40 is substantially coaxial with respect to the valve body 31. The end of the needle 40 on the opposite side of the fuel inlet 16 has a seal portion 42, which is adapted to be seated onto the valve seat 32 of the valve body 31. The needle 40 is in a substantially cylindrical shape, and has a fuel passage 44 therein. Fuel in the needle 40 flows from the fuel passage 44 into a fuel passage 24, which is in the outside of the needle 40, through fuel ports 45, 46, 47. The end of the needle 40 on the opposite side of the seal portion 42 is fixed to the movable core 22, so that the movable core 22 is substantially axially movable integrally with the needle 40. The movable core 22 may be separated from the needle 40.

The end of the movable core 22 on the side of the fixed core 12 makes contact with a spring 26. The spring 26 serves as a bias member. One end of the spring 26 makes contact with the movable core 22. The other end of the spring 26 makes contact with an adjusting pipe 28. The bias member is not limited to the spring 26. The bias member may be a blade spring, a gas damper, or a liquid damper, for example. The adjusting pipe 28 is press-inserted into the inner periphery of the fixed core 12. An amount of press-insertion of the adjusting pipe 28 is altered, so that force applied to the spring 26 can be adjusted. The spring 26 axially extends, so that the spring 26 produces axial bias force. The needle 40 and the movable core 22, which are integrated, are biased such that the seal portion 42 is seated onto the valve seat 32 by the sparing 26.

The outer periphery of the fixed core 12 is provided with a coil assembly 50. The coil assembly 50 is constructed of a coil 51, a mold member 52, and a connector 53, which are molded and integrated. The coil 51 is in a substantially cylindrical shape having the outer periphery and the inner periphery, which are coated with resin formed to be the mold member 52. The coil 51 surrounds the outer periphery of the fixed core 12 continuously with respect to the circumferential direction of the fixed core 12. The mold member 52 and a connecter 53 are integrally formed of resin. The coil 51 electrically connects with terminals 55 of the connecter 53 via wiring members 54.

The outer periphery of the coil 51 is surrounded by a housing 60, which is formed of a magnetic material such as a ferrous material to be in a substantially cylindrical shape. The housing 60 is integrally formed to be circumferentially seamless, so that the housing 60 circumferentially surrounds the outer periphery of the coil 51, which is covered with the mold member 52, continuously with respect to the circumferential direction of the coil 51. In this structure, magnetic flow can be sufficiently secured around the coil 51 when the coil 51 is supplied with electricity, so that the housing 60 may be formed of a thin wall. Thus, the housing 60 can be downsized, and weight of the housing 60 can be reduced. The housing 60 is in the substantially cylindrical shape, which is a simple shape. Specifically, axial ends (first and second axial ends) 60A, 60B of the housing 60 are in simple shapes, which do not have projections and depressions. Therefore, the housing 60 can be readily formed, so that manufacturing work of the housing 60 can be reduced.

In addition, the housing 60 is in a substantially cylindrical shape, which is circumferentially seamless. Therefore, the housing 60 can be readily formed by press forming or the like.

The housing 60 may have a seam.

The first axial end 60A of the housing 60 on the side of the holder 30 makes contact with a holder step 35 of the holder 30, so that the position of the housing 60 is defined with respect to the holder 30. The holder 30 covers the 15 ends of both the coil 51 and the housing 60 on the side of the nozzle hole 34. A portion of the holder 30 on the side of the fixed core 12 with respect to the holder step 35 has the outer diameter that is substantially the same as the inner diameter of the housing 60, so that the housing 60 can be press-inserted to the holder 30.

In this structure, the housing 60 makes contact closely with the holder 30 continuously with respect to the circumferential direction thereof by press-inserting the housing 60 to the holder 30. Therefore, the holder 30 and the housing 60, which are formed of magnetic materials, are magnetically connected.

The second axial end 60B of the housing 60 on the opposite side of the holder 30 connects with a cap 70. The cap 70 covers the ends of both the housing 60 and the coil 51 on the opposite side of the holder 30. The cap 70 is formed of a magnetic material such as a ferrous material to be in a substantially cylindrical shape. The cap 70 has a neck portion 71 and a head portion 72, which are integrally formed. The neck portion 71 is located between the outer periphery of the fixed core 12 and the inner periphery of the housing 60. The neck portion 71 has the inner diameter that is substantially the same as the outer diameter of the fixed core 12. The neck portion 71 has the outer diameter that is substantially the same as the inner diameter of the housing 60. In this structure, the neck portion 71 of the cap 70 can be press-inserted between the fixed core 12 and the housing 60. The cap 70 is press-inserted between the fixed core 12 and the housing 60. Therefore, the inner periphery of the cap 70 makes contact closely with the fixed core 12, and the outer periphery of the cap 70 makes contact closely with housing 60. Thus, the fixed core 12 and the housing 60, which are formed of magnetic materials, are magnetically connected via the cap 70.

The housing 60 has the first portion, which is press-inserted to the holder 30. The housing 60 has the second axial end 60B, which is press-inserted to the cap 70. The inner diameter and the outer diameter of the first axial end 60A of the housing 60 are respectively substantially the same as the inner diameter and the outer diameter of the second axial end 60B of the housing 60. Therefore, in this embodiment, the housing 60 is in a substantially cylindrical shape having the inner diameter, which is substantially constant axially from the first axial end 60A to the second axial end 60B. Thus, the first axial end 60A is substantially equivalent to the second axial end 60B in the housing 60. In addition, the first axial end 60A and the second axial end 60B are substantially symmetrical with respect to the axial center of the housing 60 when the axial center of the housing 60 is defined as a point of symmetry. The axial center of the housing 60 is a center point of the housing 60 with respect to the longitudinal direction of the housing 60.

The outer diameter of the head portion 72 is greater than the outer diameter of the neck portion 71. The connecting portion between the head portion 72 and the neck portion 71 defines a cap step 77. The second axial end 60B of the housing 60 on the opposite side of the holder 30 makes contact with the cap step 77 formed on the head portion 72 on the side of the neck portion 71. The housing 60 makes contact with the cap 70 in this manner, so that the position of the housing 60 on the opposite side of the holder 30 is defined with respect to the cap 70. The head portion 72 has an end surface 73 on the opposite side of the neck portion 71. The end surface 73 of the head portion 72 is substantially flat. When the injector 10 is pressed onto the engine, for example, the injector 10 can be applied with bias force using a bias member such as a spring via the head portion 72 of the cap 70.

As shown in FIG. 2, the cap 70 has an opening 74, which is formed partially along the circumferential periphery of the cap 70, so that the cap 70 is in a substantially C-shape, which is circumferentially discontinuous. The connecter 53 of the coil assembly 50 is located in the opening 74, so that the cap 70 can be distant from the connecter 53.

The holder 30 is connected with the first axial end 60A of the housing 60, and the cap 70 is connected with the second axial end 60B of the housing 60, so that the housing 60 is interposed between the holder 30 and the cap 70. The coil 51 of the coil assembly 50 is also interposed between the holder 30 and the cap 70.

Next, a manufacturing process of the injector 10 is described.

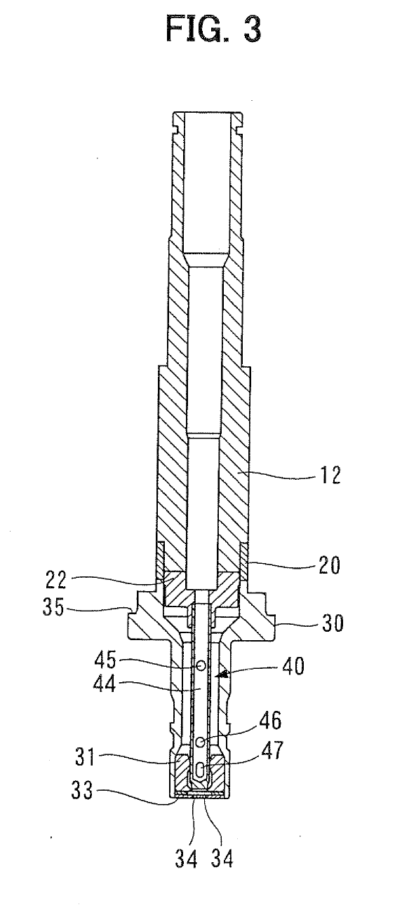

As shown in FIG. 3, the fixed core 12, the non-magnetic member 20, and the holder 30 are assembled to each other, in advance. Specifically, the holder 30 accommodates the valve body 31, the nozzle plate 33, the movable core 22, and the needle 40. The movable core 22 and the needle 40 are integrally connected to each other by press-insertion, welding, or the like. The fixed core 12 is fixed to the non-magnetic member 20 by welding or the like. The non-magnetic member 20 is fixed to the holder 30 by welding or the like.

As shown in FIG. 4, the housing 60 is provided to the fixed core 12, the non-magnetic member 20, and the holder 30, which are assembled. Specifically, the housing 60 is press-inserted to the outer periphery of the holder 30, such that the housing 60 is radially separated from the fixed core 12 by a predetermined distance. The fixed core 12 and the housing 60 define a space 36 therebetween. The housing 60 is press-inserted such that the first axial end 60A of the housing 60 on the side of the holder 30 makes contact with the holder step 35 of the holder 30. The first axial end 60A of the housing 60 on the side of the holder 30 and the second axial end 60B of the housing 60 on the side of the cap 70 are substantially symmetrical with respect to the point of symmetry, which is the axial center of the housing 60. That is, the second axial end 60B of the housing 60 on the upper side in FIG. 4 and the first axial end 60A of the housing 60 on the lower side in FIG. 4 are substantially symmetrical, and have an equivalent shape. In this structure, each of the first and second axial ends 60A, 60B of the housing 60 can be press-inserted to the holder 30. Therefore, when the housing 60 is press-inserted, the direction of the housing 60 relative to the holder 30 need not be confirmed. Therefore, assembling work of the housing 60 can be facilitated.

The housing 60 is press-inserted to the holder 30 until the housing 60 makes contact with the holder step 35 of the holder 30, so that the first axial end 60A of the housing 60 on the side of the nozzle plate 33 is supported by the holder 30. Movement of the housing 60 toward the nozzle plate 33 is restricted by abutting the housing 60 onto the holder step 35 of the holder 30. In this structure, a press-insertion margin between the inner periphery of the housing 60 and the outer periphery of the holder 30 need not be excessively strong, because of the support of the holder step 35, onto which the housing 60 abuts when the holder 30 is press-inserted to the housing 60. Consequently, axial mechanical strength of the contact portion, i.e., the press-insertion margin, in which the housing 60 connects with the housing 60, need not be enhanced. Therefore, dimensional control and strength administration of the housing 60 and the holder 30 can be facilitated.

The housing 60 is welded to the holder 30 from the outer periphery of the housing 60. In this structure, it may be difficult to secure mechanical strength of the press-insertion margin, in which the housing 60 connects with the holder 30, against sharing stress. However, the housing 60 is supported by the holder 30 by abutting onto the holder step 35, so that shearing force applied axially between the inner periphery of the housing 60 and the outer periphery of the holder 30 can be reduced. Therefore, the size and the depth of the welding portion need not be precisely controlled, even when the housing 60 is welded from the radially outer side thereof. Thus, assembling of the housing 60 can be facilitated.

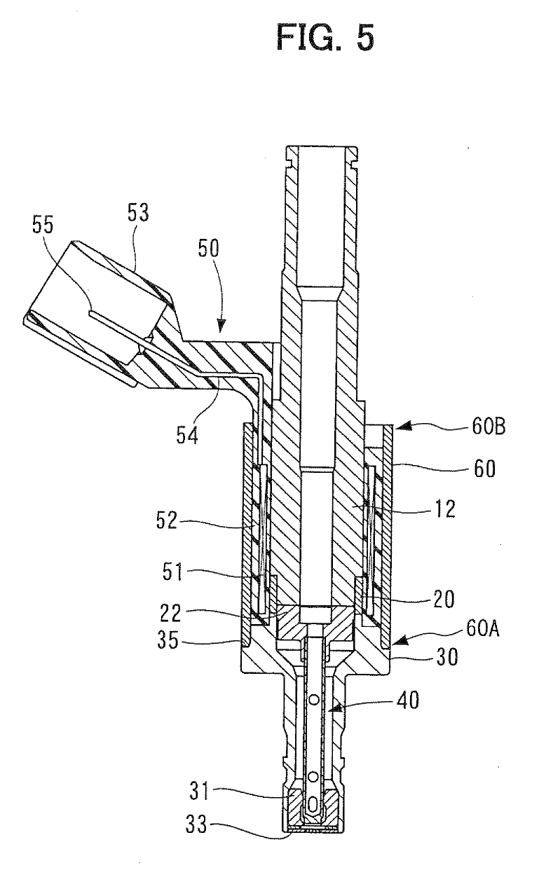

As shown in FIG. 5, the coil assembly 50 is attached to the holder 30 and the housing 60, which are assembled. Specifically, as referred to FIG. 4, the fixed core 12 and the housing 60 define the space 36 therebetween by assembling the housing 60 to the holder 30. As referred to FIG. 5, the coil 51 of the coil assembly 50 is inserted into the space 36 depicted in FIG. 4. More specifically, the coil assembly 50 is inserted from the end of the fixed core 12 on the opposite side of the valve body 31, so that the coil assembly 50 is located on the side of the outer periphery of the fixed core 12. The coil 51 of the coil assembly 50 is inserted between the fixed core 12 and the housing 60, so that the coil assembly 50 is supported between the fixed core 12 and the housing 60. The coil 51 of the coil assembly 50 makes contact with the end of the holder 30 on the side of the fixed core 12, so that the position of the coil assembly 50 is defined with respect to the axial direction of the injector 10.

In the above structure, the coil 51 of the coil assembly 50 is inserted into the space 36 between the fixed core 12 and the housing 60. Therefore, the housing 60 need not be deformed for accommodating the coil assembly 50.

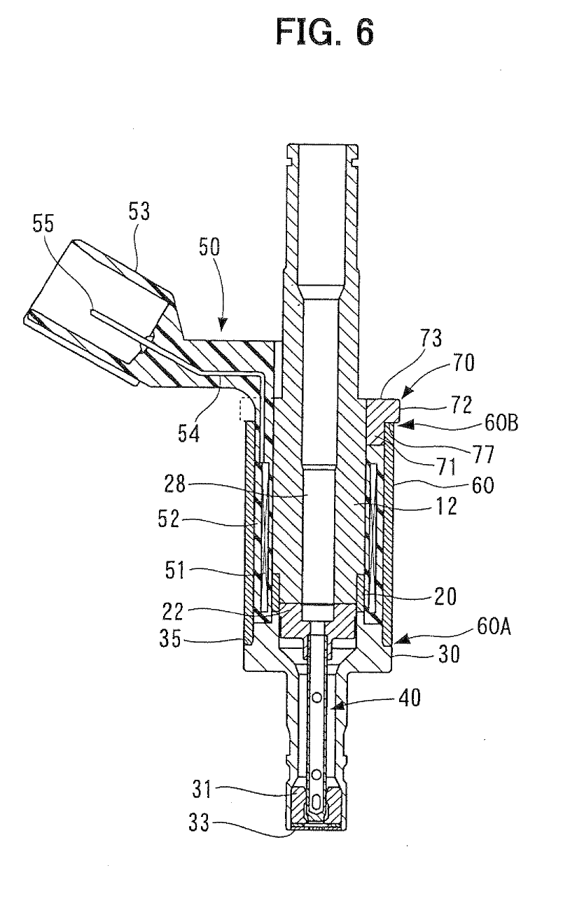

As shown in FIG. 6, the cap 70 is attached to the coil assembly 50, which is assembled to the fixed core 12 and the housing 60. The cap 70 is press-inserted to the second axial end 60B of the housing 60 on the opposite side of the holder 30, so that the cap 70 is located between the fixed core 12 and the housing 60. The cap 70 is press-inserted such that the head portion 72 makes contact with the second axial end 60B of the housing 60 on the opposite side of the holder 30. Thus, the second axial end 60B of the housing 60 on the opposite side of the nozzle plate 33 is supported by the cap 70. The housing 60 makes contact with the head portion 72 of the cap 70, so that the housing 60 is restricted from moving to the opposite side of the nozzle plate 33.

Shearing force applied between the inner periphery of the housing 60 and the outer periphery of the cap 70, which define a press-insertion margin, can be reduced by press-inserting the cap 70 and abutting the second axial end 60B of the housing 60 onto the cap 70, similarly to the press-insertion of the housing 60 to the holder 30. Consequently, axial mechanical strength of the contact portion between the housing 60 and the cap 70, need not be enhanced, so that dimensional control and strength administration of the housing 60 and the cap 70 can be facilitated.

The housing 60 may be welded to the cap 70 from the outer periphery of the housing 60. The housing 60 is axially abutted onto the cap step 77 of the cap 70, so that shearing force applied axially between the inner periphery of the housing 60 and the outer periphery of the cap 70 is reduced, even when the housing 60 is welded to the cap 70 from the radially outer side thereof. Therefore, the size and the depth of the welding portion need not be precisely controlled, even when the housing 60 is welded from the radially outer side thereof. Thus, assembling work of the cap 70 to the housing 60 can be facilitated.

As referred to FIG. 1, the spring 26 is inserted into the inner periphery of the fixed core 12, after assembling the cap 70. The adjusting pipe 28 is press-inserted to the fixed core 12 on the opposite side of the movable core 22 with respect to the spring 26, so that compression force of the spring 26 is adjusted. The filter 18 is attached to the end of the fixed core 12 on the opposite side of the holder 30, after adjusting the compression force of the spring 26. Thus, the injector 10 is assembled by the above manufacturing process. In the above manufacturing process of the injector 10, components such as the housing 60, the coil assembly 60, and the cap 70 can be respectively assembled from the opposite side of the holder 30 to the substantially uniform direction. Therefore, the components need not be axially inverted, and need not be inclined in the manufacturing process of the injector 10. Therefore, manufacturing process of the injector 10 can be facilitated, and manufacturing work of the injector 10 can be reduced.

In the above manufacturing process of the injector 10, the housing 60 is welded to the holder 30 after the housing 60 is press-inserted to the holder 30. The housing 60 is welded to the cap 70 after the cap 70 is press-inserted between the fixed core 12 and the housing 60. In these structures, strength of the press-inserted portion can be further enhanced by welding the press-inserted portion.

However, the housing 60 need not be welded to the holder 30 and/or the cap 70.

In the above structure, the coil 51 is surrounded by the housing 60, the holder 30, and the cap 70. The housing 60 surrounds both axial ends of the coil 51, so that the housing 60 need not be bent, welded, or the like, for being combined with the coil 51. The housing 60 is in a simple shape, and the housing 60 need not be formed to be in a relatively complicated shape corresponding to the coil 51. Therefore, assembling work of the housing 60 and the coil 51 can be facilitated, while the housing 60 has a simple shape.

Next, an operation of the injector 10 is described.

As referred to FIG. 1, when electricity supplied to the coil 51 is terminated, the fixed core 12 and the movable core 22 do not generate magnetic attractive force therebetween. In this condition, the movable core 22 is separated from the fixed core 12 by bias force of the spring 26, so that the seal portion 42 of the needle 40, which is integrated with the movable core 22, is seated to the valve seat 32. Thus, fuel is not injected through the nozzle hole 34.

When electricity is supplied to the coil 51, magnetic flux flows through a magnetic circuit constructed of the housing 60, the holder 30, the movable core 22, the fixed core 12, and the cap 70 by magnetism generated in the coil 51. In this condition, the fixed core 12 and the movable core 22, which are separated from each other, generate magnetic attractive force therebetween. When the magnetic attractive force becomes greater than the bias force of the spring 26, the movable core 22 and the needle 40 integrally move toward the fixed core 12, so that the seal portion 42 of the needle 40 is lifted from the valve seat 32.

Fuel flows from the fuel inlet 16 into the fuel passage 44 on the radially inner side of the needle 40 through the filter 18, the fuel passage 14 in the fixed core 12, the inside of the adjusting pipe 28, and the inside of the movable core 22. The fuel further flows from the fuel passage 44 on the radially inner side of the needle 40 into the fuel passage 24 on the radially outer side of the needle 40 through the fuel ports 45, 46, 47. The fuel flowing into the fuel passage 24 is injected through the nozzle hole 34, after passing through the gap between the valve body 31 and the needle 40, which is lifted from the valve seat 32.

When supplying electricity to the coil 51 is terminated, magnetic attractive force between the fixed core 12 and the movable core 22 is eliminated. In this condition, the movable core 22 and the needle 40, which are integrated, move to the opposite side of the fixed core 12 by bias force of the spring 26, so that the seal portion 42 of the needle 40 is seated onto the valve seat 32 once again. Thus, injection of fuel through the nozzle hole 34 is terminated.

(Modification)

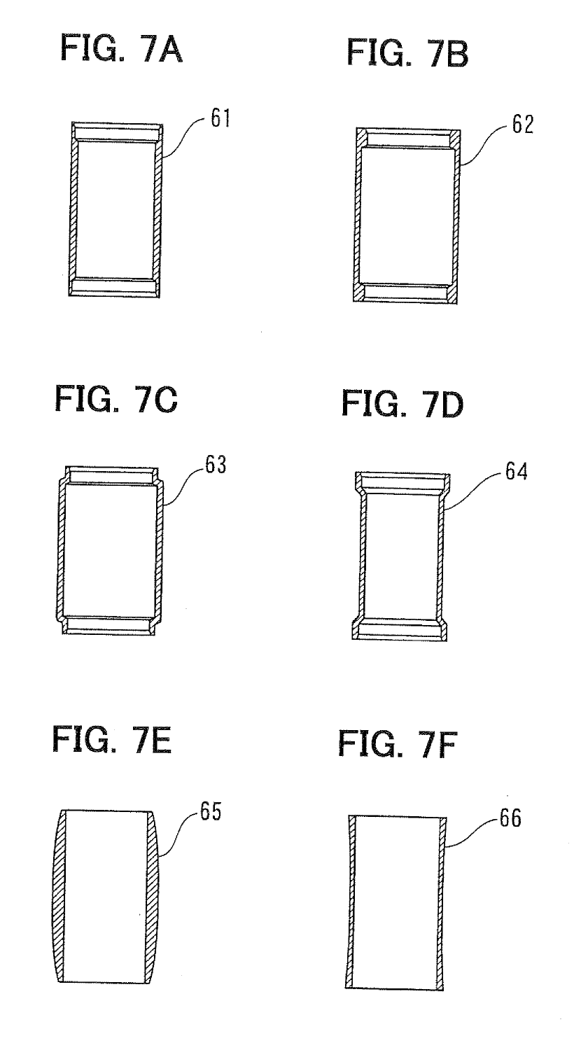

As shown in FIGS. 7A to 7F, the shapes of the housings 61 to 66 may be variously modified in accordance with the shape of the coil 51, the shape around the coil 51, and/or magnitude of magnetism passing through the housings 61 to 66.

Each of the housings 61 to 66 shown in FIGS. 7A to 7F has a first axial end, which is press-inserted to the holder 30. Each of the housings 61 to 66 has a second axial end, which is press-inserted to the cap 70. The inner diameter and the outer diameter of the first axial end of each of the housings 61 to 66 are respectively substantially equivalent to the inner diameter and the outer diameter of the second axial end of each of the housings 61 to 66.

The first axial end 60A of each of the housings 61 to 66 on the side of the holder 30 and the second axial end of each of the housings 61 to 66 on the side of the cap 70 are substantially symmetrical with respect to the axial center, i.e., the longitudinal center, which is the axis of symmetry of each of the housings 61 to 66. Therefore, when each of the housings 61 to 66 is press-inserted, the direction of each of the housings 61 to 66 relative to the holder 30 need not be confirmed. Therefore, assembling work of the housings 61 to 66 can be facilitated.

### Second Embodiment

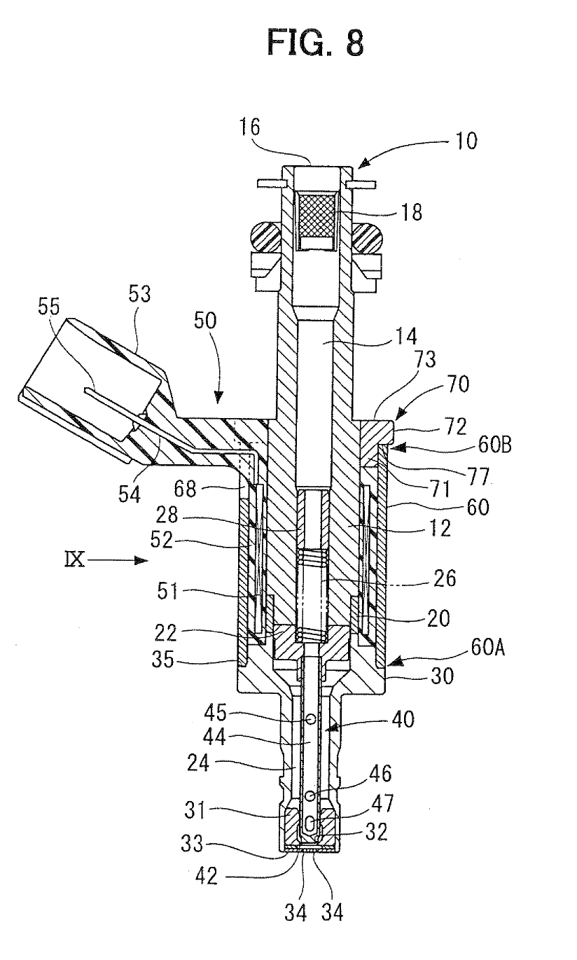

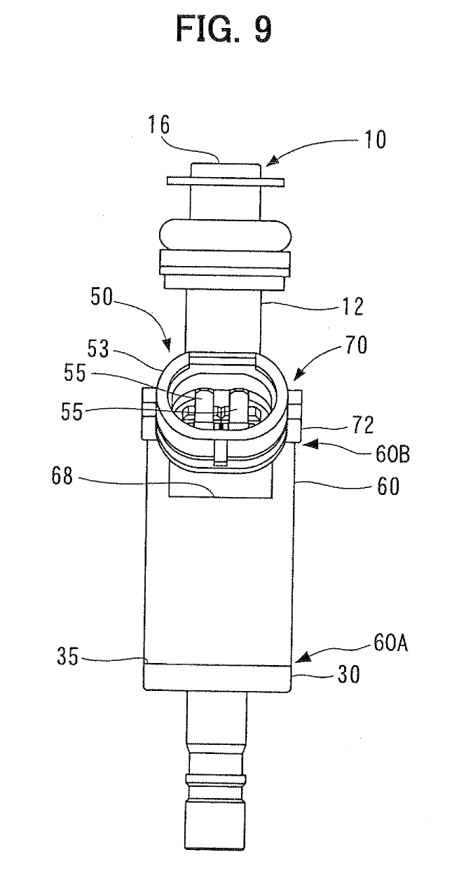

As shown in FIGS. 8, 9, the connecter 53 of the coil assembly 50 is located on the side of the holder 30, compared with the structure of the first embodiment. Therefore, the connecter 53 of the coil assembly 50 is located on the side of the holder 30 with respect to the end of the housing 60 on the side of the cap 70, compared with the structure of the first embodiment. The end of the housing 60 on the side of the cap 70 has an opening 68 correspondingly to the connecter 53. The opening 68 is formed by partially removing a portion, which extends from the second axial end 60B of the housing 60 on the opposite side of the holder 30 toward the holder 30, from the holder 30. In this structure, the coil assembly 50 can be readily inserted from the opposite side of the holder 30 into the inner periphery of the housing 60. The opening 68 may be formed axially midway through the housing 60.

### Third Embodiment

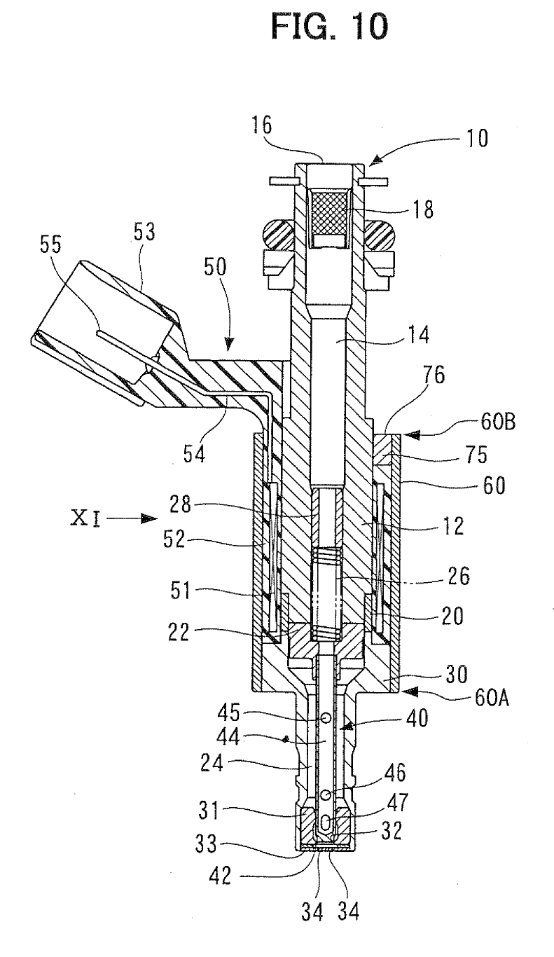

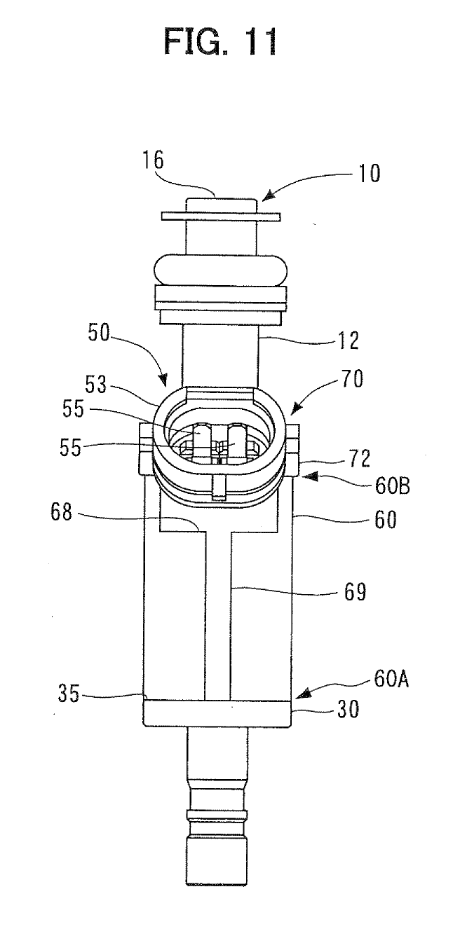

As shown in FIG. 10, the housing 60 is located around the radially outermost periphery of the holder 30. The holder 30 does not have the holder step 35 (FIG. 1) described in the first embodiment. The end surface of the housing 60 on the side of the nozzle hole 34 does not contact with the holder 30. In this construction, the housing 60 substantially entirely covers the outer periphery of the holder 30. A cap 75 is provided to the opposite side of the holder 30 with respect to the housing 60. The cap 75 has an end surface 76 on the opposite side of the holder 30. The end surface 76 of the cap 75 is located at the axial position, which is substantially the same as the axial position of the end surface of the housing 60 on the opposite side of the holder 30 with respect to housing 60. That is, the end surface 76 of the cap 75 and the end surface of the second axial end 60B of the housing 60 form a substantially flat surface, for example. In this structure, the cap 75 is entirely press-inserted between the fixed core 12 and the housing 60. In this embodiment, projections and depressions can be reduced in the holder 30 and the cap 75, so that the shapes of the holder 30 and the cap 75 can be simplified. Thus, manufacturing work of the holder 30 and the cap 75 can be facilitated, so that manufacturing cost of the injector can be reduced.

### Variation Embodiment

The movable core 22 need not be fixed to the needle 40. The movable core 22 may be axially movable with respect to the needle 40 within a predetermined range. In this structure, when the coil 51 is supplied with electricity, an impact caused by collision between the fixed core 12 and the movable core 22 can be reduced by the movement of the movable core 22 with respect to the needle 40. Thus, the movable core 22 can be restricted from bumping to the opposite side of the fixed core 12 when the coil 51 is supplied with electricity, so that improper fuel injection due to collision between the fixed core 12 and the movable core 22 can be restricted.

The housing 60 may have a seam in the outer periphery thereof. That is, the housing 60 may have a discontinuous outer periphery with respect to the circumferential direction thereof. Specifically, the housing 60 may be formed by rolling a plate member and connecting the circumferential ends of the rolled plate member to be a substantially cylindrical member.

As shown in FIG. 1 the housing 60 may have a slit 69, which is formed in the outer periphery of the housing 60 partially with respect to the circumferential direction of the housing 60. The slit 69 communicates the first and second axial ends 60A, 60B of the housing 60 with each other. In this structure, the magnetic circuit formed in the housing 60 is disconnected by the slit 69, so that eddy current can be restricted from arising circumferentially through the housing 60. Therefore, magnetism caused in the housing 60 can be quickly reduced by terminating electricity supplied to the coil 51, so that residual magnetism can be quickly reduced. Consequently, magnetic attractive force between the fixed core 12 and the movable core 22 can be quickly eliminated, so that response of the needle 40 with respect to terminating electricity can be enhanced.

In this structure, the seam lines of the housing 60 need not be in substantially linear shapes in parallel with the axis of the housing 60. The seam lines of the housing 60 may be in a shape having a projection and depression circumferentially engaging with each other. The slit 69 may be formed from one of the axial ends of the housing 60 to an axially intermediate portion of the housing 60. Both the axial ends of the slit 69 may be circumferentially closed such that the slit 69 becomes in a substantially window shape axially surrounded by both closed axial ends.

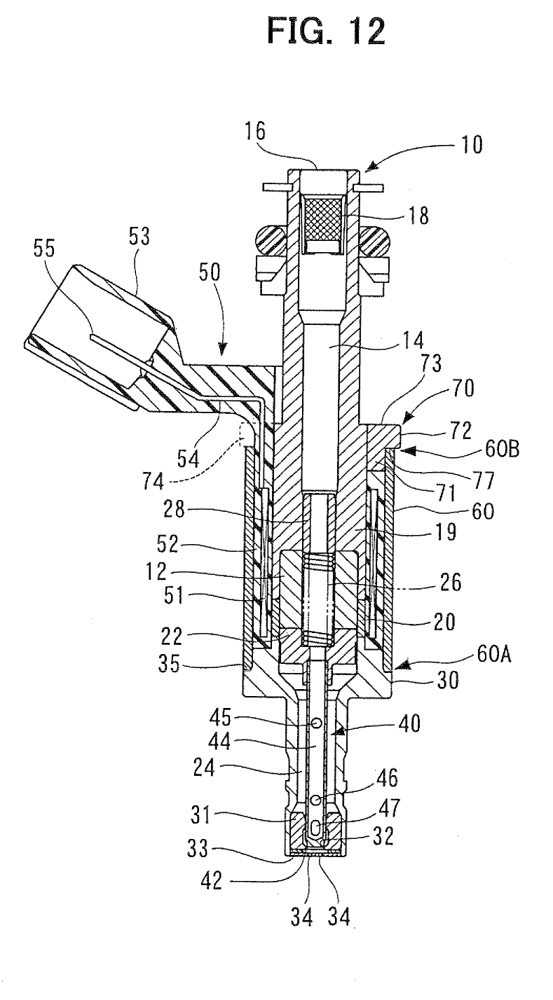

As shown in FIG. 12, a fuel connector 19, which defines the fuel passage 14 therein, may be additionally provided to the fixed core 12, instead of defining the fuel passage 14 using only the fixed core 12.

The holder may cover a first axial end of the coil. The cap may cover a second axial end of the coil on the axially opposite side of the first axial end of the coil.

The above structures of the embodiments can be combined as appropriate.

It should be appreciated that while the processes of the embodiments of the present invention have been described herein as including a specific sequence, further alternative embodiments including various other sequences and/or additional sequences not disclosed herein are intended to be within the sequences of the present invention.

Various modifications and alternations may be diversely made to the above embodiments without departing from the spirit of the present invention.

What is claimed is:

1. An injection valve comprising:
a coil that generates magnetism when being supplied with electricity;
a housing that is in a substantially cylindrical shape, the housing at least partially surrounding an outer periphery of the coil, the housing having a first axial end and a second axial end, the first axial end is located on an opposite side of the second axial end with respect to an axial direction of the housing, the housing being formed of a magnetic material;
a fixed core that is located on a radially inner side of the coil;
a movable core that is located on a radially inner side of the coil, the movable core being opposed to the fixed core, the movable core being attracted to the fixed core by magnetic attractive force generated by the coil between the movable core and the fixed core;
a valve that is movable together with the movable core with respect to an axial direction of the valve;
a holder that is formed of a magnetic material separately from the housing, the holder connecting with the first axial end of the housing, the holder accommodating the valve; and
a cap that is formed of a magnetic material separately from both the housing and the holder, the cap connecting with the second axial end of the housing.

2. The injection valve according to claim 1,
wherein holder has an interior that communicates with an exterior of the holder through a nozzle hole, and
the valve intermits injection of fuel through the nozzle hole by moving with the movable core with respect to the axial direction of the valve.

3. The injection valve according to claim 1 wherein the coil is interposed between the housing and the fixed core.

4. The injection valve according to claim 1,
wherein the valve is axially movable in the holder, and
the housing is interposed between the holder and the cap.

5. The injection valve according to claim 4, wherein the cap has a cap step that defines the position of an inner periphery of the housing.

6. The injection valve according to claim 4, wherein the holder has a holder step that defines the position of an inner periphery of the housing.

7. The injection valve according to claim 1, wherein the first axial end has an inner periphery, which has an inner diameter being substantially the same as an inner diameter of an inner periphery of the second axial end.

8. The injection valve according to claim 1, wherein the holder has an outer periphery, which has an outer diameter being substantially the same as an outer diameter of an outer periphery of the cap.

9. The injection valve according to claim 1,
wherein the housing has an axial center with respect to an axial direction of the housing, and
the housing is substantially symmetrical with respect to the axial center of the housing.

10. The injection valve according to claim 1, wherein the first axial end and the second axial end respectively have shapes, which are substantially equivalent to each other.

11. The injection valve according to claim 1, wherein the cap has a circumferential periphery that has an opening.

12. The injection valve according to claim 1, wherein the housing is integrally formed and is seamless.

13. The injection valve according to claim 1, wherein the cap has a circumferential periphery that has a slit.

14. The injection valve according to claim 13, wherein the slit extends from the first axial end to the second axial end.

15. An injection valve comprising:
a coil that has a first axial end and a second axial end, the coil generating magnetic flux when being supplied with electricity;
a housing that is in a substantially cylindrical shape, the housing at least partially surrounding an outer periphery of the coil, the housing being formed of a magnetic material;
a fixed core that is located on a radially inner side of the coil;
a movable core that is located on a radially inner side of the coil, the movable core being opposed to the fixed core, the movable core being attracted to the fixed core by magnetic attractive force generated between the movable core and the fixed core;
a valve that intermits injection of fuel through a nozzle hole by moving in conjunction with the movable core with respect to an axial direction of the valve;
a holder that is formed of a magnetic material separately from the housing, the holder covering the first axial end of the coil; and
a cap that is formed of a magnetic material separately from both the housing and fixed core, the cap covering the second axial end of the coil.

16. A method for manufacturing an injection valve, the method comprising:
assembling a movable core to the holder, which accommodates a valve, such that the movable core being axially movable in conjunction with the valve with respect to the holder;
assembling a fixed core to the holder;
press-inserting the housing to the holder such that the housing surrounds an outer periphery of the fixed core so that the housing and the fixed core define a space therebetween;
inserting a substantially cylindrical coil into the space; and
press-inserting a cap to the housing on an opposite side of the holder.

17. A method for manufacturing an injection valve, the method comprising:
inserting a valve into an inner periphery of a holder such that the valve is axially movable in the holder;
assembling a movable core to the holder such that the movable core is axially movable in conjunction with the valve with respect to the holder;
assembling a fixed core to the holder;
press-inserting any one of a first axial end and a second axial end of the housing to the holder, such that the housing surrounds an outer periphery of the fixed core so that the housing and the fixed core define a space therebetween;
inserting a substantially cylindrical coil into the space; and
press-inserting a cap to an other of the first axial end and the second axial end of the housing on an opposite side of the holder.
